(19) United States
(12) Patent Application Publication
(10) Pub. No.: US 2025/0138830 A1
(43) Pub. Date: May 1, 2025

(54) RESUMABILITY SUPPORT FOR GRAPH EXECUTION ON SINGLE-INSTRUCTION-MULTIPLE-THREAD ARCHITECTURE

(71) Applicant: Oracle International Corporation, Redwood Shores, CA (US)

(72) Inventors: Weiwei Gong, Belmont, CA (US); Harshada Chavan, Redwood Shores, CA (US); James Kearney, Bolton, MA (US); Kangnyeon Kim, Dublin, CA (US)

(21) Appl. No.: 18/384,734

(22) Filed: Oct. 27, 2023

(51) Int. Cl. G06F 9/38

(52) U.S. Cl. CPC G06F 9/3888

(57) ABSTRACT

An approach is provided for a thorough and clean way of handling graph overflows in graph execution on single instruction, multiple threads (SIMT) hardware with resumable graph support. The solution does not assume that the input and output fit in the buffers allocated in the SIMT hardware. The approach maintains state of the execution for each kernel and uses multiple iterations of graph execution, making progress in each iteration until all data items are processed through the graph on SIMT hardware. This iterative processing of the graph is transparent to the end user. For resumability, the approach treats buffers as circular buffers instead of serial buffers. With the help of counters, the approach keeps track of the start and end indexes of input and output buffers, thus achieving seamless graph resumability when re-execution is required for only a subset of kernels.

### FIELD OF THE INVENTION

The present invention relates to graph execution on single-instruction multiple-thread (SIMT) architecture and, more specifically, to handling buffer overflows at various stages of graph execution and preserving progress made in iterations of execution.

### BACKGROUND

Single instruction, multiple threads (SIMT) is an execution model used in parallel computing where single instruction, multiple data (SIMID) is combined with multithreading. The SIMT execution model has been implemented on several graphics processing units (GPUs) and is relevant for general-purpose computing on graphics processing units (GPGPU) using a combination of central processing units (CPUs) and GPUs. Compute Unified Device Architecture (CUDA) is a proprietary and closed source parallel computing platform and application programming interface (API) that allows software to use certain types of graphics processing units (GPUs) for general purpose processing. CUDA is a software layer that gives direct access to the GPU's virtual instruction set and parallel computational elements, for the execution of compute kernels.

The computational power of SIMT hardware has been lucrative for query/data processing for over a decade. An effective way of offloading query processing to SIMT is using graphs. A sequence of query operators is formulated in the form of a graph, and the graph is run on the SIMT hardware. A unit of computation that belongs to an operator is referred to as a kernel on the SIMT hardware. In a graph, the components are relayed in such a way that the successive components receive output from previous components as input streams. Such a processing approach has proven to be very efficient and to help achieve better throughput with the help of parallel processing.

A graph-based approach works seamlessly when sufficient sized input and output device buffers are allocated before launching the graph (in terms of number of rows). However, there can be two reasons for such a pre-allocation of device buffers may not be possible. First, SIMT hardware is known to have limited memory for such device buffers; therefore, in order to fit all the operators, one might decide to be conservative in allocating buffers for individual operators. Secondly, it can be difficult to predict the size of output buffers for some operators—and, in turn, the size of the input buffers for successive operators—at the time of launching execution of a graph. For example, run length encoding (RLE) expansion, filters, hash joins, etc. are operators for which output buffer size may be difficult to determine at allocation time. In such a case, if the generated output size exceeds what was allocated at the time of the graph launch, i.e., an overflow occurs, the execution results in an error and, thus, discarding of the partial results.

Currently, the industry does not have a satisfactory solution to this problem. Current approaches use a simplistic approach that assumes that the input and output buffers are large enough to accommodate all the results. If an overflow occurs, execution can fall back to CPU processing. Such an assumption not only limits the number of operators that can be offloaded to the SIMT hardware, but also breaks down a continuous graph of query operators into multiple subgraphs, thus leading to longer end-to-end query runtime. There is also additional time wasted due to partial data processing until an error is encountered.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 depicts the control flow for graph execution using single-instruction multiple-thread hardware in accordance with an illustrative embodiment.

FIG. 2 depicts an example graph to be executed on single instruction multiple thread architecture in which each kernel receives input from a parent kernel in accordance with an illustrative embodiment.

FIG. 3 depicts an example graph to be executed on single instruction multiple thread architecture in which a kernel receives input from two parent kernels in accordance with an illustrative embodiment.

FIG. 4 is a block diagram that illustrates a computer system upon which aspects of the illustrative embodiments may be implemented.

FIG. 5 is a block diagram of a basic software system 500 that may be employed for controlling the operation of computer system 500 upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The illustrative embodiments provide an approach that provides a thorough and clean way of handling graph overflows with the help of resumable graph support. A graph may be built to perform operations for a query. An overflow occurs when the amount of data items to be output exceeds the size of the output buffer. The solution does not assume that the input and output fit in the buffers allocated in the SIMT hardware. The approach maintains state of the execution for each kernel and uses multiple iterations of graph execution, making progress in each iteration until all data items are processed through the graph on SIMT hardware. This iterative processing of the graph is transparent to the end user.

The large size of a graph can lead to overflows at various steps of the operation. Therefore, it is more difficult to control resumability in a graph execution, unlike in a single-kernel case. Any of the intermediate buffers can overflow and overflow can occur only for a subset of kernels, thus leading to detecting no-ops for the remaining kernels, etc. The approach of the illustrative embodiments can detect and handle all these cases through the use of circular buffers and can avoid redundant operations.

Previous solutions assume that each kernel must start processing the input beginning at index 0 and must end at the index (size of the buffer—1). Similarly, in the output buffer, the entire space is available to be written to. However, for resumability, the illustrative embodiments treat these buffers as circular buffers instead of serial buffers. With the help of counters, the approach of the illustrative embodiments keeps track of the start and end indexes of input and output buffers. These counters are extremely helpful in achieving seamless graph resumability when re-execution is required for only a subset of kernels.

### Graph Execution on SIMT Hardware

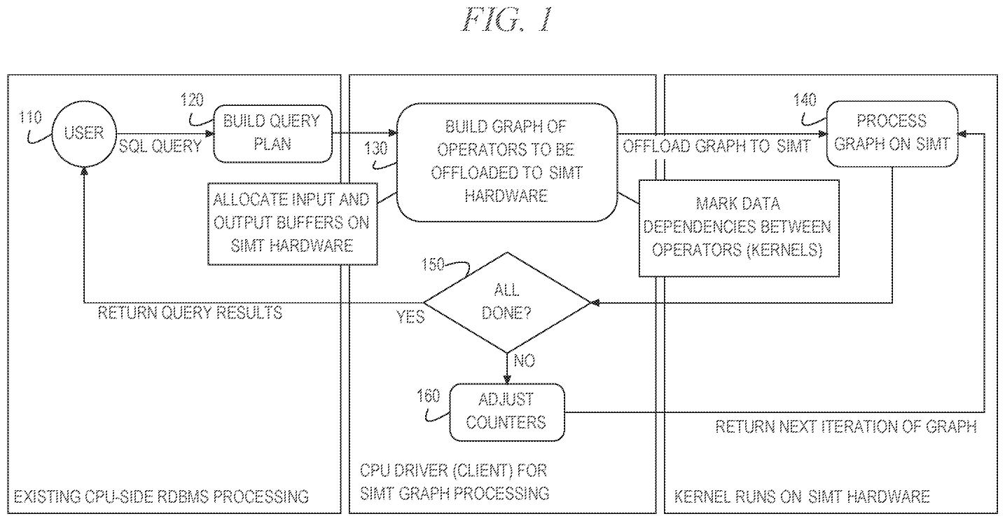

FIG. 1 depicts the control flow for graph execution using single-instruction multiple-thread (SIMT) hardware in accordance with an illustrative embodiment. When a user 100 submits an SQL query, the relational database management system (RDBMS) query parser parses the query to build the query plan (block 120), which is a directed acyclic graph of query operators. The graph query operators may include, for example, a decompression operator, a join operator, group-by operator, etc. The central processing unit (CPU) driver (i.e., the client) for the SIMT graph execution then parses this query plan further to build a graph to be offloaded to the SIMT hardware (block 130). This process involves two steps. First, the client allocates input and output buffers for each operator, called a kernel, in the SIMT hardware memory (e.g., dynamic random-access memory (DRAM)). Second, the client establishes dependencies between these kernels. Note that one query operator may map to multiple kernels. Such a graph is then offloaded onto the SIMT hardware for execution.

Each kernel of the graph runs on the SIMT hardware to process the graph (block 140). When execution returns to the client, the client checks whether the graph has been fully executed (block 150). If the graph was fully executed (block 150:YES), then query results are copied back to the CPU and returned to user 110. If the graph was not fully executed (block 150:NO), then the counters are adjusted to indicate how much data has already been processed (block 160) and the next iteration of the graph is initiated (block 140). This process continues until the graph is fully processed.

### Circular Buffer Implementation

The resumability of graphs on SIMT hardware is achieved with the help of a set of counters that keep track of the input and output buffers to indicate the start and end of processing. Various examples of how overflows can occur at different stages of processing and how graph execution can be resumed multiple times until all kernels are done processing the entire data are described in further detail below with reference to a set of counters for each kernel. A structure containing these counters is passed across all kernels to maintain the state of the operation. Each kernel may have different values of these counters.

The counters for tracking progress of kernels for resumability support for graph execution are as follows:

input_current_index: This counter represents the first item to start processing from the input buffer. For the first iteration of the graph, the input_current_index will be 0 (zero). Each time the kernel processes data items from the input buffer, the kernel increments input_current_index by the number of data items processed.

input_last_index: This counter represents the last item to be processed from the input buffer. For the first iteration, the input_last_index will be set to the following:
min(data size, input buffer size)—1
   The data size being stored in the input buffer cannot be greater than the input buffer size. In an embodiment, each time data items are added to the input buffer, input_last_index is incremented by the number of data items added. For example, if the input buffer size is 1000, and 1000 data items are being added to the input buffer, then input_current_index will be initialized to 0, and the data items will be added from input_last_index=0 to input_last_index=999. Because the input buffer is a circular buffer, input_last_index can be less than input_current_index, meaning that data items have been added to the input buffer beyond the input buffer size. For example, if after the previous iteration, input_current_index=750 and input_last_index=999 with an input buffer size of 1000, then incrementing input_last_index by one would result in input_last_index=0. Adding another 500 data items in this manner would result in input_current_index=750 and input_last_index=499.

output_current_index: This counter represents the first slot in the output buffer to which the output has been written. For the first iteration of the graph, output_current_index will be set to 0 (zero). This value is also modified by the consumer of the result to indicate up to which index the items have been consumed.

output_last_index: This counter represents the last slot in the output buffer to which the output has been written. For the first iteration of the graph, output_last_index will be set to min(data size, output buffer size—1). For example, in a first iteration, if the output buffer size is 1000, and the kernel produces 1000 output data items, then output_current_index will be initialized to 0, and the data items will be added from output_last_index=0 to output_last_index=999. In a next iteration, if output_current_index has been updated by another kernel to the value 500, then the kernel can add another 500 data items to the start of the output buffer. Because the output buffer is a circular buffer, output_last_index can be incremented from 999 to 0. Adding another 500 data items in this manner would result in output_current_index=500 and output_last_index=499.

Incrementing input_last_index to be equal to input_current_index or incrementing output_last_index to be equal to output_current_index would be an invalid operation, because there cannot be more data items stored than slots in the buffer. If input_current_index is equal to input_last_index, for example, then the first item to start processing is the same as the last item to be processed, i.e., a single data item stored in the buffer.

According to the example implementation above, the current index (input_current_index or output_current_index) is equal to the last index (input_last_index or output_last_index) when the buffer is empty. However, if there is one data item in the buffer, then the current index is equal to the last index, because the first data item to be processed in the input buffer or provided as output in the output buffer is the same as the last data item to be processed or provided as output. There are solutions for resolving this problem. In one solution, a separate counter is used to count the number of data items in the buffer, the value of which ranges from zero, meaning the buffer is empty, to the size of the buffer, meaning the buffer is full. Thus, in the example implementation, if the current index is equal to the last index, then the separate counter may be consulted to determine whether the buffer is empty or contains one data item. In an alternative solution, a binary flag is used to indicate whether the buffer is empty or contains at least one data item.

The implementation described herein is an example implementation. Other implementations of circular buffers can be used without departing from the spirit and scope of the illustrative embodiments described herein.

### Graph Examples

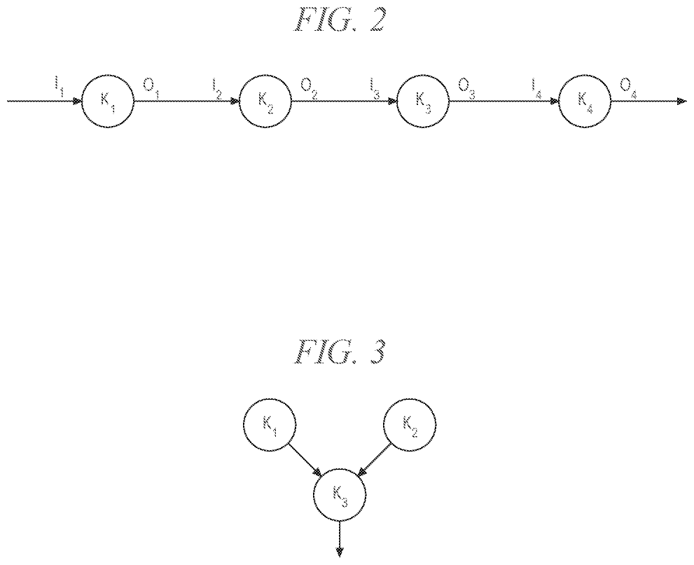

FIG. 2 depicts an example graph to be executed on single instruction multiple thread architecture in which each kernel receives input from a parent kernel in accordance with an illustrative embodiment. In the depicted example, the graph consists of four kernels Kₙ. Each kernel Kₙ has an input buffer In and an output buffer Oₙ. The output of each kernel Kₙ(Oₙ) is relayed as input to the next kernel Kₙ₊₁(Iₙ₊₁) in the graph. The output of the last kernel K₄(O₄) is provided as the output of the graph. That is, in the example implementation, the output buffer of one kernel Kₙ(Oₙ) is not duplicated as the input buffer of the next kernel Kₙ₊₁(Iₙ₊₁). Rather, kernel Kₙ writes output data items to the same buffer from which kernel Kₙ₊₁ reads data items. There is a serial dependency between kernels.

Assume in the depicted example that the initial input size is 100 data items (e.g., rows of a database table), the device input buffer size is 50, and the device output size is 100 for K₁. All kernels have 100 as the device output buffer size in the example implementation. All counters mentioned in these examples are 0-based; therefore, for a buffer size of 100, the counter value would have a range of [0, 99].

Initially, the first 50 data items (e.g., rows) are loaded into the input buffer of K₁, and the counters are set as follows:

K₁.input_current_index = 0
K₁.input_last_index = 49
K₁.output_current_index = 0
K₁.output_last_index = 0

The first graph iteration begins with processing K₁. Consider, for example, that K₁ processes 40 data items from the input before resulting in an overflow, thus generating 100 output data items in its output buffer. Therefore, at the end of K₁, the counters would be set as follows (changed values are shown in bold):

K₁.input_current_index = 40
K₁.input_last_index = 49
K₁.output_current_index = 0
K₁.output_last_index = 99

The first graph iteration continues by processing K₂. Because K₂ takes in the output of K₁, its input buffer size is 100. The input buffer counters for K₂ and are set as follows:

K₂.input_current_index = 0
K₂.input_last_index = 99

Consider, for example, that K₂ generates one output data item per input data item (i.e., a 1:1 ratio) and, thus, does not overflow. It follows that K₂ consumes all 100 data items it got as input from K₁ and produces 100 data items as output. The output_current_index of K₁ is updated to reflect the data items consumed by K₂. Therefore, at the end of K₂, the counters would be updated as follows:

K₁.input_current_index = 99
K₂.input_current_index = 99
K₂.input_last_index = 99
K₂.output_current_index = 0
K₂.output_last_index = 99

The first graph iteration then continues by processing K₃. Because the input buffer of K₃ is empty at this point, K₃ takes in the output of K₂. The input buffer counters for K₃ and are set as follows:

K₃.input_current_index = 0
K₃.input_last_index = 99

Consider that K₃ overflows after processing 75 rows from its input buffer, thus generating 100 data items in its output buffer. The output_current_index of K₂ is also updated to reflect the data items consumed by K₃. Therefore, at the end of K₃, the counters would be updated as follows:

K₂.output_current_index = 75
K₃.input_current_index = 75
K₃.input_last_index = 99
K₃.output_current_index = 0
K₃.output_last_index = 99

The first graph iteration then continues by processing K₄. Because the input buffer of K₄ is empty at this point, K₄ takes in the output of K₃. The input buffer counters for K₄ and are set as follows:

K₄.input_current_index = 0
K₄.input_last_index = 99

Consider that K₄ overflows after having processed 60 data items from its input buffer, thus writing 100 data items to its output buffer. The output_current_index of K₃ is also updated to reflect the data items consumed by K₄. Therefore, at the end of K₄, the counters would be updated as follows:

K₃.output_current_index = 60
K₄.input_current_index = 60
K₄.input_last_index = 99
K₄.output_current_index = 0
K₄.output_last_index = 99

At the end of the first iteration of the graph, an overflow was observed in kernels K₁, K₃, and K₄. Therefore, the client must resume the graph execution. The results in the output buffer of K₄ are returned to the client to avoid overwriting results. K₄. output_last_index is updated to 0 to reflect that the output buffer of K₄ is empty. Any remaining data items in the output buffers of the other kernels will remain until they are processed by the next kernel in the graph. In the second iteration, the counters will further help each kernel to make progress beyond what was done in the first iteration.

The second iteration begins with processing K₁. Because the first 40 input data items have already been processed in the first iteration, the client replaces those with data items 50-89 from the original 100 data items [0, 99]. Therefore, all data items from 0-49 are to be processed. Also, because K₁. output_current_index, as set by K₂, and K₁. output_last_index both equal 99, this indicates that the output buffer of K₁ is empty. In this case, these counters can be reset to 0. Thus, in the beginning, the counters of K₁ are as follows:

K₁.input_current_index = 40
K₁.input_last_index = 39
K₁.output_current_index = 0
K₁.output_last_index = 0

Because the input and output buffers are circular, K₁. input_current_index>K₁. input_last_index. Because all items from the input buffer must be processed, in one example embodiment the input indexes of K₁ can be updated as follows:

K₁.input_current_index = 0
K₁.input_last_index = 49

Consider in this iteration K₁ processes all 50 data items from its input buffer without any overflow and writes 75 data items to its output buffer. Therefore, at the end of K₁, the counters are updated as follows:

K₁.input_current_index = 49
K₁.input_last_index = 49
K₁.output_current_index = 0
K₁.output_last_index = 74

Also, because all input data items have been processed at the end of K₁, K₁. input_current_index and K₁. input_last_index both equal to 49. This indicates that the input buffer is empty, and the counters can be reset to 0. Therefore, after the reset, the counters are updated as follows:

K₁.input_current_index = 0
K₁.input_last_index = 0
K₁.output_current_index = 0
K₁.output_last_index = 74

The second iteration of the graph continues by processing K₂. Because K₂. input_current_index and K₂. input_last_index are both equal to 99 from the last iteration, this indicates that the input buffer is empty, and the values can be reset to 0. Because K₃ in the previous iteration of the graph had set K₂. output_current_index=75, the current iteration has the first 75 spaces [0, 74] available to write to, and there are 25 spaces [75, 99] occupied by the previous iteration. Because K₂ produces output in 1:1 proportion to the input in this example, K₂, K₂ can process all 75 values from the output buffer of K₁. Prior to processing K₂, the counters are as follows:

K₂.input_current_index = 0
K₂.input_last_index = 74
K₂.output_current_index = 75
K₂.output_last_index = 99

Therefore, it can process 75 data items from its input buffer (which is also O₁) and write to the available 75 spaces [0, 74] of its output buffer. K₂ also updates the output_current_index of its parent to 75 to indicate that it has consumed 75 data items. Therefore, at the end of K₂, the counters are updated as follows:

K₁.output_current_index = 75
K₂.input_current_index = 74
K₂.input_last_index = 74
K₂.output_current_index = 75
K₂.output_last_index = 74

Because K₂. input_current_index and K₂. input_last_index are both equal to 74, meaning the input buffer is empty, the values can be reset to 0. Also, because the output buffer is full, K₂. output_current_index and K₂. output_last_index can be reset to 0 and 99, respectively. Thus, the counters are reset as follows:

K₂.input_current_index = 0
K₂.input_last_index = 0
K₂.output_current_index = 0
K₂.output_last_index = 99

The second iteration of the graph continues by processing K₃. In the previous iteration, K₄ had only consumed 60 data items leaving 40 unprocessed values in O₃ [60, 99]. Consider in this iteration K₃ does not overflow and consumes all 100 data items from its input buffer and produces new output in the first 10 slots of O₃. Therefore, prior to processing of K₃, the counters are updated as follows:

K₂.output_current_index = 99
K₃.input_current_index = 99
K₃.input_last_index = 99
K₃.output_current_index = 60
K₃.output_last_index = 9

The second iteration of the graph continues by processing K₄. After the previous iteration, K₃ had 40 data items remaining in its input buffer [60, 99], and K₃ adds 10 new data items for a total of 50 data items available for K₃ to consume. This is reflected in the following counter values:

K₄.input_current_index = 60
K₄.input_last_index = 9
K₄.output_current_index = 0
K₄.output_last_index = 0

Consider that K₄ overflows after processing 40 data items from its input buffer. Therefore, at the end of K₄, the counters are updated as follows:

K₃.output_current_index = 0
K₄.input_current_index = 0
K₄.input_last_index = 9
K₄.output_current_index = 0
K₄.output_last_index = 99

At the end of the second iteration of the graph, an overflow was observed in kernel K₄. Again, the data items in O₄ must be offloaded to the client to free the output buffer for more output data items. K₄. output_last_index is updated to 0 to reflect that the output buffer of K₄ is now empty. Any remaining data items in the output buffers of the other kernels will remain until they are processed by the next kernel in the graph, and the client must resume the graph execution. In the third iteration of the graph, the counters will further help each kernel to make progress beyond what was done in the first iterations.

The third iteration of the graph begins by processing K₁. There are still 10 data items from the input to be processed. In the third iteration, the entire input device buffer is available for use, and the remaining 10 data items are loaded into the input buffer of K₁. Consider in the third iteration K₁ processes all data items from its input buffer without an overflow but does not generate any output. Thus, at the end of K₁, the counters are updated as follows:

K₁.input_current_index = 0
K₁.input_last_index = 0
K₁.output_current_index = 0
K₁.output_last_index = 0

The third iteration of the graph continues by processing K₂. After the previous iteration, K₂ had no data items remaining in its input buffer, and there are no new data items in the output buffer of K₁. The kernel detects that there is no new input to be processed and skips execution in K₂. Such a detection of NO-OPs is important because it avoids redundant computations. Because it is a NO-OP, at the end of K₂, the counters are updated as follows:

K₂.input_current_index = 0
K₂.input_last_index = 0
K₂.output_current_index = 0
K₂.output_last_index = 0

The third iteration continues by processing K₃. In the last iteration, K₄ had only consumed 40 data items from O₃, leaving 10 data items to be processed in O₃. K₂ did not write any new data items to its output buffer; therefore, the input buffer of K₃ is empty. In this iteration, K₃ does not have any new data items to process from K₂, because the output buffer of K₂ is empty. Therefore, at the end of K₃, the counters are updated as follows:

K₃.input_current_index = 0
K₃.input_last_index = 0
K₃.output_current_index = 0
K₃.output_last_index = 9

The third iteration continues by processing K₄. Consider that K₄ does not overflow and consumes the remaining 10 data items, writing 25 data items to its output buffer. Therefore, at the end of K₄, the counters are updated as follows:

K₃.output_current_index = 9
K₄.input_current_index = 9
K₄.input_last_index = 9
K₄.output_current_index = 0
K₄.output_last_index = 24

At the end of the third iteration of the graph, no overflow was observed in any kernel. The data items in O₄ must be offloaded to the client to free the output buffer for more output data items. K₄. output_last_index is updated to 0 to reflect that the output buffer of K₄ is now empty. There are no remaining data items in the output buffers of the other kernels.

The third iteration of the graph completes the query execution, because all 100 data items from the initial input have been processed and there are no data items left to process in any of the input or output buffers of the kernels. After each iteration, the client checks how much of the input has been processed and whether there was an overflow in the previous iteration. The client invokes a new iteration only when needed. In this case, all 100 data items were processed by the graph generating 225 data items as output.

FIG. 3 depicts an example graph to be executed on single instruction multiple thread architecture in which a kernel receives input from two parent kernels in accordance with an illustrative embodiment. In this example, kernels K₁, K₂, and K₃ have input and output buffer size of 100. The original input size of K₁ and K₂ is 200, meaning there are 200 data items in the initial data set to be processed by the graph.

The first iteration of the graph begins with processing of K₁ and K₂. The initial counters for K₁ are as follows:

K₁.input_current_index = 0
K₁.input_last_index = 99
K₁.output_current_index = 0
K₁.output_last_index = 0

The initial counters for K₂ are as follows:

K₂.input_current_index = 0
K₂.input_last_index = 99
K₂.output_current_index = 0
K₂.output_last_index = 0

In this example, because K₃ has two parent kernels, it sets input buffer counters for both K₁ and K₂. The input buffer counters for K₁ are designated as K₃. input_current_index[1] and K₃. input_last_index [1], and the input buffer counters for K₂ are designated as K₃. input_current_index[2] and K₃. input_last_index [2].

Consider both K₁ and K₂ process the first 100 data items in the first iteration and produce 100 data items of output. After processing, the counters for K₁ are updated as follows:

K₁.input_current_index = 0
K₁.input_last_index = 99
K₁.output_current_index = 0
K₁.output_last_index = 0

The initial counters for K₂ are updated as follows:

K₂.input_current_index = 0
K₂.input_last_index = 99
K₂.output_current_index = 0
K₂.output_last_index = 0

An overflow occurs in K₁ and K₂; therefore, they will be resumed in a subsequent iteration.

Consider, for example, the data items are rows of one or more database tables, and K₃ is a join-like kernel, which requires the output of K₁ to be available for all output branches of K₂. Therefore, in the first iteration of the graph, even if all of the output data items of K₁ have been utilized, K₁ cannot proceed to the next batch of input data items until all data items batched from K₂ have been processed. The counters for K₃ are updated as follows:

K₁.output_current_index = 0
K₂.output_current_index = 99
K₃.input_current_index[1] = 0
K₃.input_last_index[1] = 99
K₃.input_current_index[2] = 99
K₃.input_last_index[2] = 99
K₃.output_current_index = 0
K₃.output_last_index = 99

Here, because K₃ set the output_current_index of K₁ to zero, this indicates to K₁ that none of its output has been consumed by K₃. Thus, K₁ will not overwrite any data items in its output buffer. At the end of this iteration of the graph, the data items in the output buffer of K₃ must be offloaded to the client to free the output buffer for more output data items. K₃. output_last_index is updated to 0 to reflect that the output buffer of K₃ is now empty.

The second iteration of the graph continues by processing K₁ and K₂. Because the output buffer of K₁ is still full, K₁ does not process anything in this iteration. However, K₂ can process a second batch of input. At the end of the processing, the counters for K₁ are updated as follows:

K₁.input_current_index = 99
K₁.input_last_index = 99
K₁.output_current_index = 0
K₁.output_last_index = 99

The initial counters for K₂ are updated as follows:

K₂.input_current_index = 99
K₂.input_last_index = 99
K₂.output_current_index = 0
K₂.output_last_index = 99

The second iteration continues by processing K₃, which processes outputs from both K₁ and K₂. After processing, the counters are updated as follows:

K₁.output_current_index = 99
K₂.output_current_index = 99
K₃.input_current_index[1] = 99
K₃.input_last_index[1] = 99
K₃.input_current_index[2] = 99
K₃.input_last_index[2] = 99
K₃.output_current_index = 0
K₃.output_last_index = 99

Here, because K₃ set the output_current_index of K₁ to 99, this indicates to K₁ that all of its output has been consumed by K₃. Thus, K₁ can now overwrite data items in its output buffer. At the end of this iteration of the graph, the data items in the output buffer of K₃ must be offloaded to the client to free the output buffer for more output data items.

K₃. output_last_index is updated to 0 to reflect that the output buffer of K₃ is now empty.

After the second iteration of the graph, K₁ still has the next batch of data items to process. The third and fourth iterations of the graph are similar to the first and second iterations above, except that the output of K₁ would be the second batch processed by K₃.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

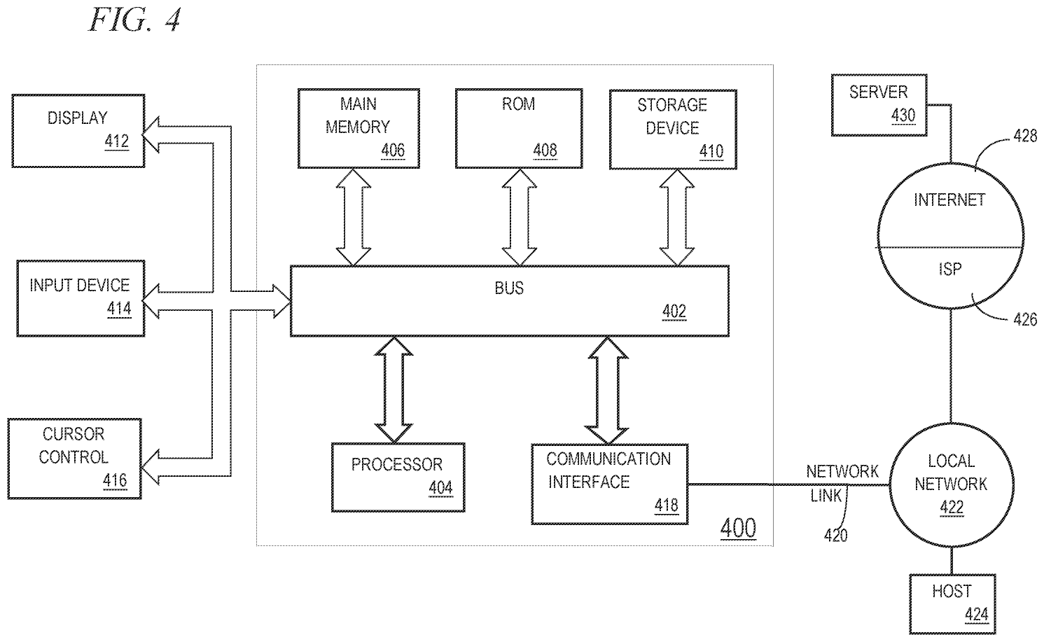

For example, FIG. 4 is a block diagram that illustrates a computer system 400 upon which aspects of the illustrative embodiments may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world-wide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

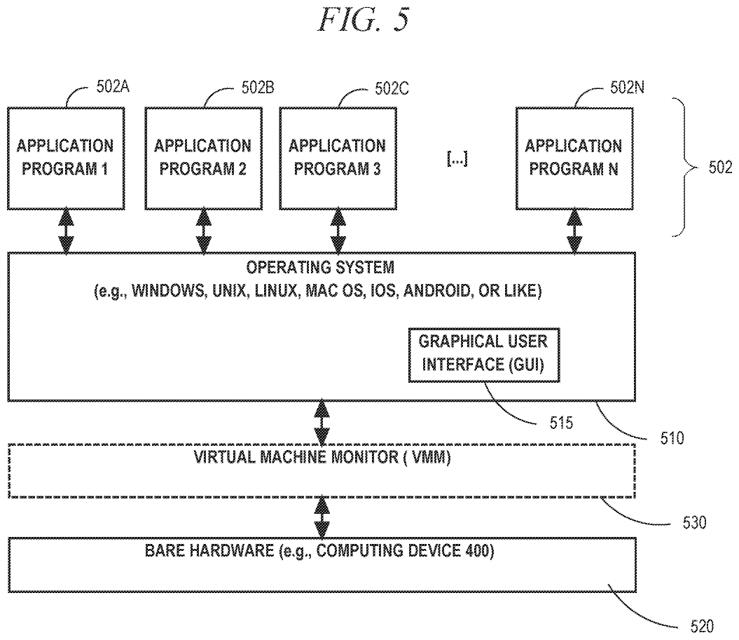

FIG. 5 is a block diagram of a basic software system 500 that may be employed for controlling the operation of computer system 500 upon which aspects of the illustrative embodiments may be implemented. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computer system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
building a graph of query operators for a query plan for a query, wherein:
the graph represents a plurality of kernels including at least a first kernel and a second kernel,
each kernel of the plurality of kernels performs a query operator of the query plan, and
the second kernel performs a second operation that is dependent on a first operation performed by the first kernel;
executing the query plan on single-instruction-multiple-thread (SIMT) hardware, wherein:
each kernel of the plurality of kernels executes on a plurality of threads of the SIMT hardware,
each kernel of the plurality of kernels has an associated input buffer and output buffer,
each kernel has a set of counters comprising an input current index counter and input last index counter associated with the input buffer of the kernel and an output current index counter and output last index counter associated with the output buffer of the kernel,
the query plan is executed in a sequence of iterations of the graph on the SIMT hardware,
for each iteration of the graph, each kernel processes a set of input data items from the input buffer of the kernel, writes a set of output data items to the output buffer of the kernel, and updates the set of counters of the kernel; and
responsive to determining the graph is fully processed, returning a query result set;
wherein the method is performed by one or more computing devices.

2. The method of claim 1, wherein:
for each given iteration of the graph, each kernel:
updates the input current index counter to specify a first data item to start processing from the input buffer of the kernel in a next iteration,
updates the input last index counter to specify a last data item available to be processed from the input buffer in the next iteration,
updates the output current index counter to specify a first slot in the output buffer to which output has been written during the given iteration, and
updates the output last index counter to specify a last slot in the output buffer to which output has been written during the given iteration.

3. The method of claim 1, wherein:
the input buffer of the second kernel is the output buffer of the first kernel, and
for a given iteration of the graph, the second kernel updates an output current index counter of the first kernel based on a number of data items consumed from the output buffer of the first kernel during the given iteration.

4. The method of claim 1, wherein for a given iteration of the graph, a given kernel fills the output buffer of the given kernel without consuming all data items of the input buffer of the given kernel.

5. The method of claim 1, wherein the input buffer and output buffer of each kernel are circular buffers.

6. The method of claim 1, wherein the graph is a directed acyclic graph.

7. The method of claim 1, wherein the query operators include a decompression operator, a join operator, or a group-by operator.

8. The method of claim 1, wherein a given query operator is mapped to two or more kernels of the plurality of kernels.

9. The method of claim 1, wherein the second operation of the second kernel depends on operations performed by two or more kernels within the plurality of kernels.

10. The method of claim 1, further comprising:
responsive to determining the graph is not fully processed, initiating a next iteration of the graph.

11. One or more non-transitory storage media storing one or more sequences of instructions which, when executed by one or more computing devices, cause:
building a graph of query operators for a query plan for a query, wherein:
the graph represents a plurality of kernels including at least a first kernel and a second kernel,
each kernel of the plurality of kernels performs a query operator of the query plan, and
the second kernel performs a second operation that is dependent on a first operation performed by the first kernel;
executing the query plan on single-instruction-multiple-thread (SIMT) hardware, wherein:
each kernel of the plurality of kernels executes on a plurality of threads of the SIMT hardware,
each kernel of the plurality of kernels has an associated input buffer and output buffer,
each kernel has a set of counters comprising an input current index counter and input last index counter associated with the input buffer of the kernel and an output current index counter and output last index counter associated with the output buffer of the kernel,
the query plan is executed in a sequence of iterations of the graph on the SIMT hardware,
for each iteration of the graph, each kernel processes a set of input data items from the input buffer of the kernel, writes a set of output data items to the output buffer of the kernel, and updates the set of counters of the kernel; and
responsive to determining the graph is fully processed, returning a query result set.

12. The one or more non-transitory storage media of claim 11, wherein:
for each given iteration of the graph, each kernel:
updates the input current index counter to specify a first data item to start processing from the input buffer in a next iteration,
updates the input last index counter to specify a last data item available to be processed from the input buffer in the next iteration,
updates the output current index counter to specify a first slot in the output buffer to which output has been written during the given iteration, and
updates the output last index counter to specify a last slot in the output buffer to which output has been written during the given iteration.

13. The one or more non-transitory storage media of claim 11, wherein:
the input buffer of the second kernel is the output buffer of the first kernel, and
for a given iteration of the graph, the second kernel updates an output current index counter of the first kernel based on a number of data items consumed from the output buffer of the first kernel during the given iteration.

14. The one or more non-transitory storage media of claim 11, wherein for a given iteration of the graph, a given kernel fills the output buffer of the given kernel without consuming all data items of the input buffer of the given kernel.

15. The one or more non-transitory storage media of claim 11, wherein the input buffer and output buffer of each kernel are circular buffers.

16. The one or more non-transitory storage media of claim 11, wherein the graph is a directed acyclic graph.

17. The one or more non-transitory storage media of claim 11, wherein the query operators include a decompression operator, a join operator, or a group-by operator.

18. The one or more non-transitory storage media of claim 11, wherein a given query operator is mapped to two or more kernels of the plurality of kernels.

19. The one or more non-transitory storage media of claim 11, wherein the second operation of the second kernel depends on operations performed by two or more kernels within the plurality of kernels.

20. The one or more non-transitory storage media of claim 11, further comprising:
responsive to determining the graph is not fully processed, initiating a next iteration of the graph.
